(19) United States
(12) Patent Application Publication
(10) Pub. No.: US 2023/0021230 A1
(43) Pub. Date: Jan. 19, 2023

(54) METHOD AND APPARATUS FOR SECURING A LADDER

(71) Applicant: LadderGuard LLC, Lawrenceville, GA (US)

(72) Inventor: Jesus Antonio Escobar Santana, Brookhaven, GA (US)

(73) Assignee: LadderGuard LLC, Lawrenceville, GA (US)

(21) Appl. No.: 17/859,106

(22) Filed: Jul. 7, 2022

Related U.S. Application Data
(60) Provisional application No. 63/219,225, filed on Jul. 7, 2021.
(60) Provisional application No. 63/239,800, filed on Sep. 1, 2021.

(51) Int. Cl. E06C 7/18; E02D 5/80

(52) U.S. Cl. CPC E06C 7/188; E02D 5/801

(57) ABSTRACT

A ladder anchoring system utilizing a ground anchoring device and a series of strap assemblies to secure the ladder in position and hold the ladder tightly against both the ground surface and the associated structure to prevent tipping or falling. Further, the ladder anchor system of the present disclosure is quickly and easily installed and/or adjusted to allow for ease of manufacturing, assembly, and/or use thereof.

### CROSS REFERENCE TO RELATED APPLICATIONS

This application claims the benefit of U.S. Provisional Application Ser. No. 63/219,225 filed on Jul. 7, 2021 and further claims benefit of U.S. Provisional Application Ser. No. 63/239,800 filed on Sep. 1, 2021; the disclosures of which are incorporated herein by reference.

### TECHNICAL FIELD

The present invention relates generally to the field of safety devices. More specifically, the present invention relates to a method and apparatus for anchoring and securing ladders and other devices against an associated structure. In particular, the present invention relates to a ladder anchor system utilizing a ground anchor and a series of tension strap assemblies to secure the ladder against an associated structure to prevent movement and/or tipping of the ladder during use.

### BACKGROUND

Ladders are very common and useful tools utilized across a variety of applications, including personal, residential, commercial, and/or industrial applications. In many instances, ladders are fixed in place or otherwise supported by additional sections of the ladder, such as with A-frame or step-ladders. In many smaller commercial applications and/or residential uses, however, extension ladders are common tools that are operated by leaning the ladder against a structure and utilizing the ladder to climb to a higher level. For example, extension ladders are commonly used to climb to the roof of the associated structure.

One of the most common uses for extension ladders is for roof access on a residential home or similar building for maintenance, repair, replacement, inspection, and the like. It is common for such activities that the ladder may be set up and leaned against the associated structure and then utilized to traverse up and down the ladder multiple times over a period of time. In these situations, where the ladder is a non-permanent installation but is expected to be utilized multiple times, it is common practice to anchor the ladder is some manner to attempt to maintain the proper position and stabilization of the ladder to prevent tipping and/or falling over during use. If the ladder is not anchored or is not properly secured, the repeated use can cause the ladder to shift, and over time, to fall. This can cause significant injury to the user of the ladder and/or can cause difficulty for the user should they be stranded on the upper level (e.g. on the roof of a home or building) if the ladder were to tip and fall.

Traditional anchoring methods and devices tend to anchor the ladder either at the point of contact with the associated structure or at the opposite end where the ladder contacts the ground surface. Such traditional anchoring methods and devices may include attempting to secure the ladder at the point of contact with the associated structure typically involve the use of hooks or braces that often cause damage or require modification to the structure itself. For example, anti-tipping and securing braces are utilized which may be screwed or bolted to the roof of a structure allowing the ladder to then rest within the brace to prevent tipping thereof. This causes additional damage and/or repair work required once the brace is removed and further the brace is unable to be utilized while repairing the damage caused by the attachment thereof.

Methods for securing the base of the ladder include weighting the base of the ladder or otherwise attempting to secure the ladder to the ground surface using various anchoring methods or devices. Weighting the base of the ladder is not always effective and/or safe in that the weight can shift or otherwise be inadequate to fully support the weight of a person and/or materials being moved up and down the ladder repeatedly. This can cause an imbalance, which may then also cause the ladder to tip or fall, again potentially causing serious harm and/or damage to the person's using the ladder and/or the associated structure itself. Anchoring the base of the ladder is also less than ideal as the anchors have to be placed properly and often to not entirely prevent movement of the top of the ladder against the associated structure.

Many of the current solutions that are highly effective are complex and difficult to install, and often require modification to the ladder and/or to the associated structure to work. For example, brackets can be installed on or around the ladder and then screwed into the roof surface. While effective, this requires modification of the ladder (installing brackets) and causes damage to the roof from the screws. Often, given the difficulty and complexity of these solutions, they are less likely to be employed by the user due to the difficulty in setting them up and installing/uninstalling them.

Less complex solutions, while more likely to be actually implemented, tend to be less effective and/or less secure. As the proper securement of a ladder is a safety issue, it is important to utilize a system and method for anchoring the ladder that is both secure but also easy to install and remove.

### SUMMARY

The present disclosure addresses these and other issues by providing a ladder anchoring system utilizing a ground anchoring device and a series of strap assemblies to secure the ladder in position and hold the ladder tightly against both the ground surface and the associated structure to prevent tipping or falling. Further provided, the ladder anchor system of the present disclosure is quickly and easily installed and adjusted to allow for ease of manufacturing, assembly, and/or use thereof.

In one aspect, an exemplary embodiment of the present disclosure may provide a ladder anchoring apparatus comprising: a ground anchor having a handle, a body, and a base operable to securely engage a ground surface; an upper strap assembly having at least one ladder attachment strap operable to connect to a ladder and a tensioning strap operable to connect the at least one ladder strap to the ground anchor; and a lower strap assembly operable to connect to the ladder at a first end thereof and to the ground anchor at a second end thereof.

In another aspect, an exemplary embodiment of the present disclosure may provide a method of securing a ladder comprising: placing a ladder in position on a ground surface and against an associated structure; engaging a ground anchor having a handle portion, a body, and a base with the ground surface; connecting a first end of at least one ladder attachment strap to a first side rail of the ladder and a second end of the at least one ladder attachment strap to a second side rail of the ladder; connecting a first end of a tensioning strap to the at least one ladder strap and a second end of the tensioning strap to the ground anchor; connecting a first end of a lower strap assembly to the ladder and a second end of the lower strap assembly to the ground anchor; applying downward force on the ladder towards the ground anchor by applying tension to the tensioning strap via a first tensioning mechanism operably engaged therewith; and applying lateral force on the ladder towards the ground anchor by applying tension to the lower strap assembly via a second tensioning mechanism operably engaged therewith.

In yet another aspect, and exemplary embodiment of the present disclosure may provide a ground anchor comprising: a crossbar; a first side bar; a second side bar, the crossbar, first side bar, and second side bar defining a handle section; at least one extendable handle at an end of the crossbar, the at least one extendable handle is movable between a first position wherein the at least one extendable handle is parallel and adjacent to one of the first and second side bars and a second position wherein the at least one extendable handle extends outwardly from the end of the crossbar and is substantially planar therewith; a body; and a base operable to securely engage a ground surface.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a side elevation view of a ladder anchoring system as installed on a ladder and against an associated structure, according to one aspect of the present disclosure.

FIG. 2 is a front elevation view of a ground anchor of a ladder anchoring system, according to one aspect of the present disclosure.

FIG. 3A is a front elevation view of the ground anchor from FIG. 2 and a first embodiment of an upper strap assembly of a ladder anchor system, according to one aspect of the present disclosure.

FIG. 3B is a front elevation view of the ground anchor from FIG. 2 and a second embodiment of an upper strap assembly of a ladder anchor system, according to one aspect of the present disclosure.

FIG. 3C is a front elevation view of the ground anchor from FIG. 2 and a third embodiment of an upper strap assembly of a ladder anchor system, according to one aspect of the present disclosure.

FIG. 3D is a front elevation view of the ground anchor from FIG. 2 and a fourth embodiment of an upper strap assembly of a ladder anchor system, according to one aspect of the present disclosure.

FIG. 4 is a top plan view of a lower strap assembly of a ladder anchor system, according to one aspect of the present disclosure.

FIG. 5 is a front elevation operational view of an upper strap assembly of a ladder anchor system, according to one aspect of the present disclosure.

FIG. 6 is a front elevation operational view of the anchor and attachments to the upper and lower strap assemblies of a ladder anchor system, according to one aspect of the present disclosure.

FIG. 7 is a side elevation operational view of a ladder anchoring system as installed on a ladder and against an associated structure, according to one aspect of the present disclosure.

Similar numbers refer to similar parts throughout the drawings.

### DETAILED DESCRIPTION

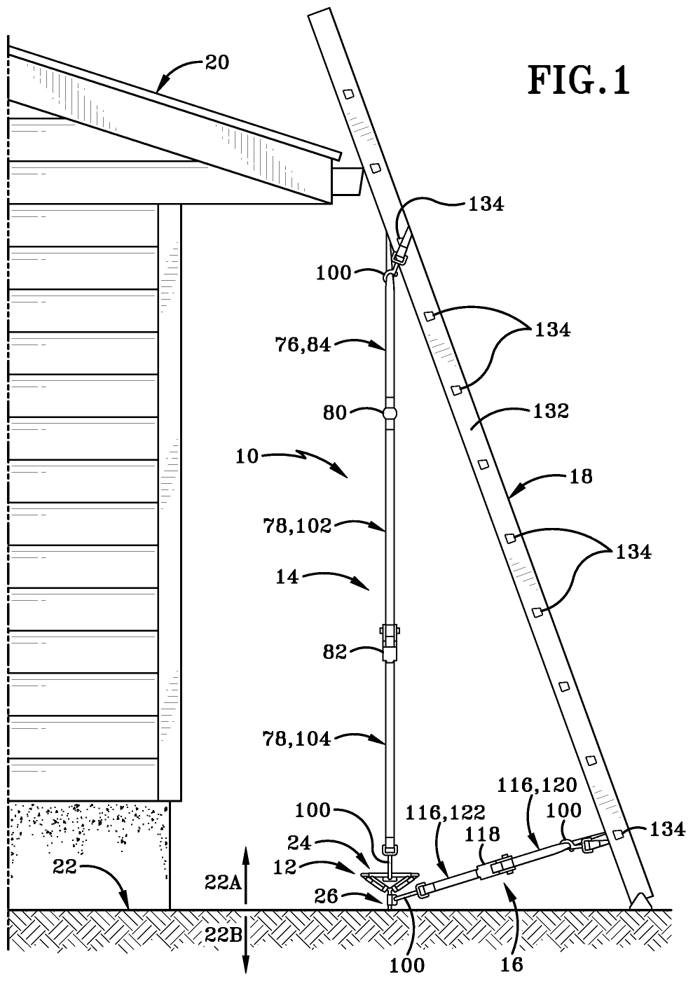

With reference to FIG. 1, a ladder anchoring apparatus is shown and generally indicated as anchor system 10. Anchor system 10 may include a ground anchor 12, an upper strap assembly 14, and a lower strap assembly 16. As contemplated and discussed further herein, anchor system 10 may be utilized to secure a ladder 18 against a structure 20 and on the ground surface 22 to prevent unwanted movement, tipping, and/or falling thereof during use. It will be understood, however, that anchor system 10 may be utilized to secure other similar apparatuses as desired. For example, anchor system 10 may be utilized to secure material transporting devices such as trash chutes or conveyor belts, scaffolding, or other similar devices that may be temporarily placed against an associated structure.

As discussed further below, ladder 18 may be any suitable type of ladder; however, it is contemplated that ladder 18 may be an unsupported ladder, i.e. a ladder that is not fixed in a permanent installation, and/or a ladder that does not have its own self-supporting means (for example, an A-frame or step-ladder). Thus, as shown and described herein, ladder 18 may be a standard extension ladder; however, it will be readily apparent that other similar ladder types and/or other similar equipment may be secured by anchor system 10 as described further herein.

Structure 20 may be any suitable structure where it may be desirable to secure a ladder 18 or other similar device adjacent thereto. As shown and discussed herein, structure 20 may be a house or other building wherein is desirable to gain access to a roof or upper level thereof, as discussed further below. It will be understood, however, that structure 20 may be any suitable structure including buildings, decks, railings, balconies, stairways, or the like, and anchor system 10 may be utilized to secure a ladder 18 or other similar device adjacent thereto for normal use thereof.

Ground surface 22 is contemplated to be any suitable surface for use with anchor system 10 including soil, gravel, or other loose or packed substrates into which ground anchor 12 may be installed, as discussed further below. Although not contemplated for use on hard and/or impermeable surfaces such as asphalt or concrete, it will be understood that anchor 12 may be readily modified and/or adapted for use with such surfaces as discussed further below. As shown in the figures, ground surface 22 may include the area above ground (shown at reference 22A) and below ground (22B). These areas are defined relative to the surface plane of ground surface 22, as discussed further herein.

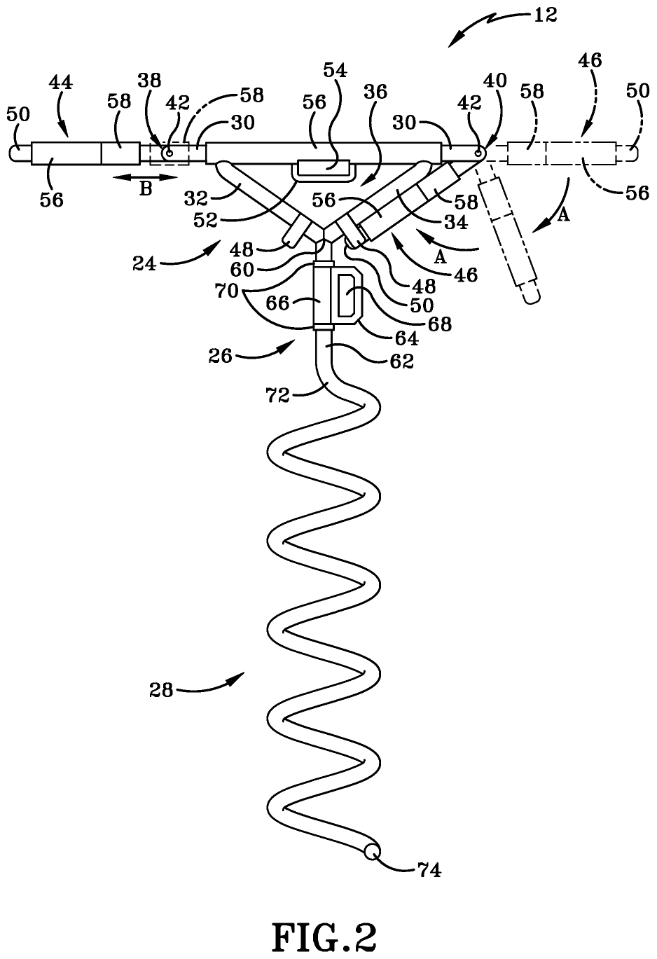

With reference to FIG. 2, ground anchor 12 is shown and will be described in more detail. Ground anchor 12 may generally be separated into three sections, namely, a handle section 24, a body 26, and an anchor base 28. Handle section 24 may include a crossbar 30, a first side bar 32, and a second side bar 34. Crossbar 30 and each of first and second side bars 32 and 34 may be operably connected and may encircle or otherwise define a central opening 36 therethrough, which may provide support to the ground anchor 12 and may further allow for engagement with upper strap assembly 14, as described herein. Crossbar 30 may be generally horizontal to the ground surface 42 and may have a first end 38 opposite a second end 40 defining a horizontal or transverse direction therebetween. Each of first and second end 38 and 40 may include a pivot pin 42 for operable connection to a first handle 44 and a second handle 46, respectively. Handle section 24 may further include a pair of handle clips 48 with one clip 48 disposed on each of first and second side bars 32 and 34 for operable engagement with a locking tip 50 of first and second handles 44 and 46, as described further herein. Generally speaking, handle section 24 may have a triangular or similar shape (as shown) suitable to transfer rotational force applied to the handles 44 and 46 into the anchor base 28 to engage ground anchor 12 with the ground surface 22, as discussed further herein.

Handle section 24 may further include a handle D-ring 52 extending from crossbar 30 and further defining a D-ring aperture 54 therein. D-ring 52 may extend in any direction. As shown, D-ring 52 may extend into the central opening 36. D-ring 52 and D-ring aperture 54 may allow for operable engagement to the upper strap assembly 14 and the straps thereof as discussed further below. D-ring 52 may be integrally formed with crossbar 30 or may be a separate component attached thereto through any suitable attachment means.

As mentioned above and as described in further detail with regards to the operation thereof below, first and second handles 44 and 46 may be pivotable between a first position wherein the handles are collapsed and parallel to the first and second side bars 32 and 34 and engaged with the handle clips 48 to secure them in a stowed position and a second position wherein first and second handles 44 and 46 are extended outwardly and in the same horizontal plane as crossbar 30. This is best seen in FIG. 2 by arrows A showing the collapsing of second handle 46 as discussed further below.

Crossbar 30 and first and second handles 44 and 46 may further include a gripping surface 56 or grip 56 which may be a padded sleeve, a textured surface, or an applied material such as a rubberized coating or the like, and may be provided to allow ease of grip of the ground anchor 12 during installation and removal thereof, as discussed further below. First and second handles 44 and 46 may further include a slide lock 58, which may be movable to allow slide lock 58 to cover pivot pin 42 and the pivotal joint between first and second handles 44 and 46 and crossbar 30 to prevent unwanted collapsing thereof when in the extended second position. Slide lock 58 is best seen in FIG. 2 at arrow B, indicating the slidable movement thereof, as discussed further below.

Generally, crossbar 30, first and second side bars 32 and 34, and ground anchor 12 as a whole may be formed of any suitable material including metal, such as steel, stainless steel, galvanized steel or the like. It is contemplated that each component of ground anchor 12 may be formed of a similar material such as solid and/or tubular steel to impart strength into ground anchor; however, it will be understood that any other suitable materials, including alloys and/or combinations of the materials may be utilized. For example, handles 44 and 46 may be formed of a first material such as aluminum while the remaining portions of ground anchor 12 may be formed of a second material such as steel.

Body 26 of ground anchor 12 may be a generally vertical section, shown as vertical bar 62, which may meet with first and second side bars 32 and 34 to form a junction 60 therewith. This junction 60 may be a weld or other type physical connection between first and second side bars 32 and 34 and vertical bar 62 to provide a continuous connection between handle section 24 and body 26 of ground anchor 12. Alternatively, this junction 60 may simply define the point at which these sections meet on what is otherwise a continuous length of material that is bent or formed into the handle section 24 and body 26. Body 26 may further define a vertical axis about which the ground anchor 12 may be rotated to engage and/or disengage the base 28 with the ground surface 22.

Body 26 may further include or support a body D-ring 64 thereon utilizing a D-ring sleeve 66, which may be a tubular section of D-ring 64 that may be slid over or otherwise surround the vertical bar 62 of body 26. According to one aspect, D-ring sleeve 66 may be held in place with one or more collars 70 above and/or below sleeve 66 to simultaneously allow rotational movement of D-ring 64 about vertical bar 62 while preventing vertical movement of D-ring 64. According to another aspect, D-ring 64 and/or D-ring sleeve 66 may be permanently affixed such as through welding or the like to vertical bar 62. D-ring 64 may further define a D-ring aperture 68 therein for operable connection to the lower strap assembly 16 as discussed further herein.

Body 26 of ground anchor 12 may be continuous with the anchor base 28 in that vertical bar 62 may bend (referenced as first bend 72 in FIG. 2) and continue in a spiral helix shape down to a tip 74 of anchor base 28 as discussed further herein. It is contemplated that body 26 and anchor base 28 may be one continuous piece of material with the delineation therebetween being the first bend 72. First bend 72 may further represent point where ground anchor 12 interacts with the ground surface 22 such that anchor base 28 is contemplated to be entirely below the ground surface 22 in the area indicated as 22B. First bend 72 is contemplated to be approximately level with the ground surface 22, and body 26 and handle section 24 are contemplated to be above ground surface 22 in the area indicated as 22A when ground anchor 12 is installed properly therein.

According to other aspects, ground anchor 12 may have other configurations and/or other features as dictated by the desired implementation. For example, according to one embodiment (not shown), ground anchor 12 may have an extended and/or one-piece cross bar 30 with grips 56 disposed at first and second ends 38 and 40 thereof, and may further omit handles 44 and 46, slide locks 58, and handle clips 48.

According to another embodiment, ground anchor 12 may have or include a support plate (not shown) that may allow for different configurations and/or locations of D-rings 52 and/or 64, or may alternatively replace D-rings 52 and/or 64 with other mounting surfaces or connectors.

According to another aspect, ground anchor 12 may have or include a strap management and/or storage device that may allow the upper strap assembly 14 and/or lower strap assembly 16 to be stowed when not in use. According to this aspect, a strap management or storage device may be integrated with the ground anchor to allow the upper and/or lower strap assemblies 14 and/or 16 to remain attached to the ground anchor 12 even when not in use. According to one embodiment (not shown), a strap management and/or storage device may be mounted to the crossbar 30 of the ground anchor 12 or may alternatively be removably attached to the crossbar 30 or the body 26 of ground anchor 12.

It will be understood that the ground anchor 12 may therefore be modified as desired or as dictated by the desired implementation to provide one or more of the above exemplary features, or may be further modified as desired to provide additional features, so long as the ground anchor 12 maintains the functionality of securing the upper and lower strap assemblies 14 and 16 while engaging a ground surface 22 to securely hold a ladder 18, as described further herein.

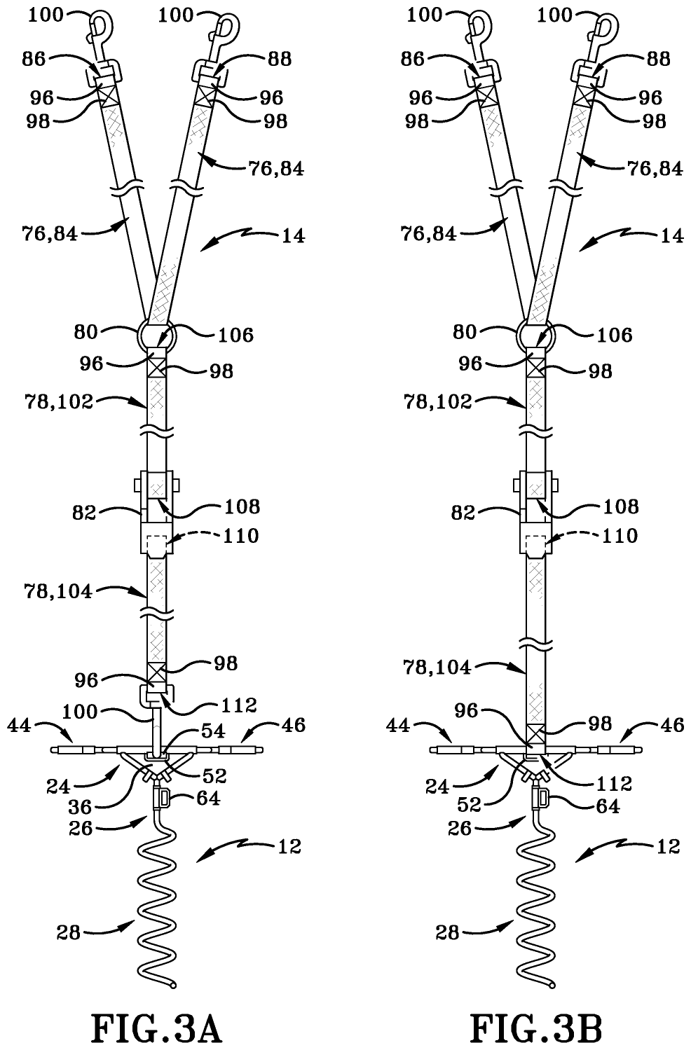

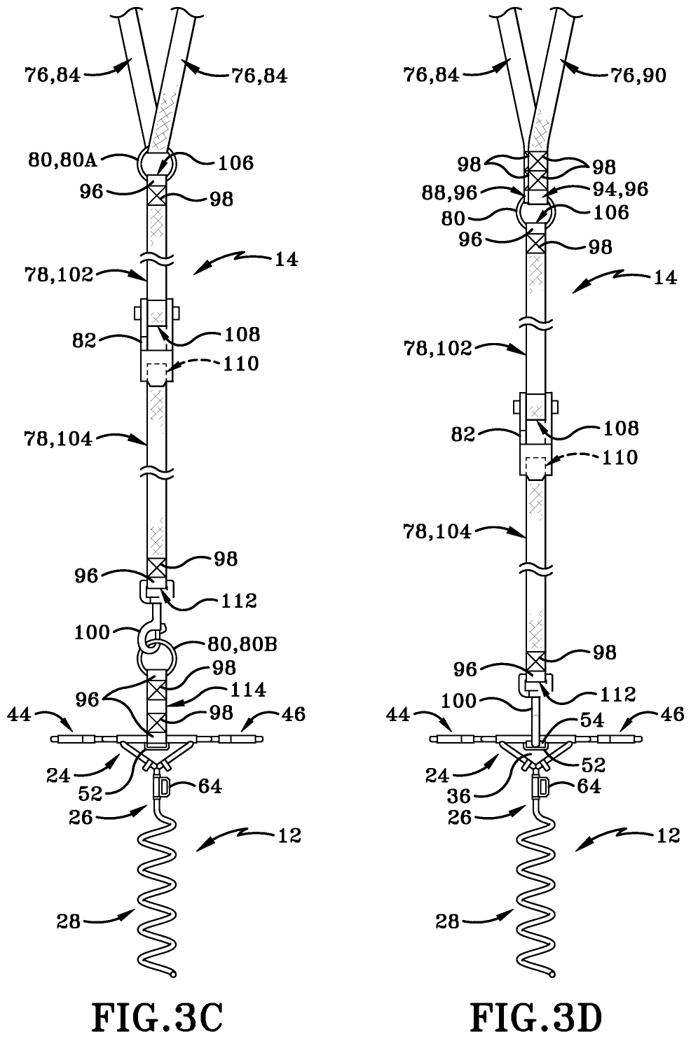

With reference to FIGS. 3A-3D, the upper strap assembly 14 is shown and will now be described in more detail. At its most basic, upper strap assembly 14 may include one or more ladder attachment straps 76 and a tensioning strap 78, which may be operationally connected via an O-ring 80 or other similar attachment device. In general, both ladder attachment straps 76 and tensioning strap 78 may generally be formed of any suitable material including nylon webbing, stretched canvas, or other similar material. According to one aspect, ladder attachment straps 76 and/or tensioning strap 78 may be or include an elastic or stretchable material to provide tension thereon. According to another aspect, upper strap assembly 14 may include a tensioning mechanism 82 on one or more of the ladder attachment straps 76 and/or tensioning strap 78, as discussed further herein. O-ring 80 may be any suitable structure or device operable to connect to ladder attachment straps 76, tensioning strap 78, or to other elements of anchor system 10. Accordingly, as used herein, O-ring 80 will be understood to refer to any suitable device operable to allow the connections described herein.

Although described and shown in FIGS. 3A-3D as separate embodiments of upper strap assembly 14, it will be readily recognized and understood that these embodiments may be interchangeable and are representative of some optional modifications to the upper strap assembly 14. These examples and embodiments will be understood to be exemplary configuration and/or uses and may be further modified or adopted for other similar uses remaining within the scope of the disclosure presented herein.

Accordingly, a first embodiment is shown in FIG. 3A and may include a single ladder attachment strap 76, indicated as first strap 84, having a first end 86 and a second end 88 spaced apart therefrom. Each of first and second ends 86 and 88 may be connected a fastening device or fastener 100, which is discussed further below. According to one aspect, first and/or second ends 86 and/or 88 may have a portion thereof wrapped or looped around a portion of the fastener 100 creating a wrapped portion or loop 96. These ends may be secured back to the strap 76, 84 and secured in place by stitching or (referred to as stitching or stitched portion 98) by any other suitable means including stitching, riveting, welding, or the like or may alternatively include any type of fastener or fastening device as dictated by the desired implementation. Loop 96 and stitching 98 may create a permanent or semi-permanent attachment between first strap 84 and fasteners 100.

Fastener 100 may be any suitable fastening device. As shown herein, fasteners 100 are illustrated as quick-release hooks 100; however, it will be understood that any suitable fastening device operable to secure the first and/or second ends 86 and 88 of first strap 84 to the associated structures may be utilized. Some non-limiting examples of fastening devices may include split O-rings, carabineers, quick-release hooks, clamps, or any other suitable fastening mechanisms as dictated by the desired implementation. According to another aspect, fasteners 100 may be or include additional components to allow the fastener 100 to be removably attached to strap 84, as desired.

As indicated in FIG. 3A, first strap 84 may be free of any tensioning mechanisms (although may include elastic material if desired, as mentioned above) as it is contemplated that a tensioning mechanism 82 may be readily employed on the tensioning strap 78, as discussed further below. According to one aspect of this embodiment, ladder attachment strap 76, or more particularly first strap 84, may be threaded through O-ring 80 to position the first and second ends 86 and 88 thereof on opposite sides of the O-ring 80, thus allowing the ends 86 and 88 and fasteners to engage with the sides 132 and/or rungs 134 of ladder 18, as discussed further below, to securely connect thereto.

Tensioning strap 78 may have a first piece 102, which may extend from a first end 106, which may be secured to O-ring 80 to a second end 108, which may be connected to a tensioning mechanism 82. Tensioning strap 78 may further have a second piece 104 with a first end 110 connecting to the tensioning mechanism 82 and a second end 112 connecting to the ground anchor 12, as discussed further below.

Tensioning mechanism 82 may be a ratcheting or ratchet strap tensioner or any other suitable tensioning device including, but not limited to, tension screw assemblies or other suitable mechanisms. Tensioning mechanism 82 may be operable to take up slack in the tensioning strap 78 to pull the straps 76 and 78 of the upper strap assembly 14 tight and to provide downward force on the ladder 18, as discussed below.

As with ladder attachment straps 76, the ends 106, 108, 110, and/or 112 of first and second pieces 102 and 104 of tensioning strap 78 may be secured to associated elements such as O-ring 80, tensioning mechanism 82, anchor 12, and/or fastener(s) 100 via a similar loop 96 and stitching section 98 to securely fasten the ends 106, 108, 110, and/or 112 to the associated elements. According to another aspect, first end 106 of first piece 102 and second end 112 of second piece 104 may be attached via the loop 96 and stitching 98 while second end 108 of first piece 102 and first end 110 of second piece 104 may be removably engaged with tensioning mechanism 82, as dictated by the desired implementation.

With continued reference to FIG. 3A, second end 112 of second piece 104 may connect to a quick-release style fastener 100, which may then be utilized to connect the second piece 104 of tensioning strap 78 to the anchor 12 via crossbar 30 and D-ring 52. In particular, fastener 100 may clip or otherwise attach to crossbar 30 through D-ring aperture 54, which may provide a secure attachment between tensioning strap 78 and anchor 12.

With reference now to FIG. 3B, a second embodiment of upper strap assembly 14 is shown therein. This second embodiment may be substantially similar or identical to the first embodiment of upper strap assembly 14 shown in FIG. 3A except that second end 112 of second piece 104 may connect directly to the crossbar 30 utilizing loop 96 and stitching 98. This embodiment is therefore contemplated to have second piece 104 securely and permanently connected with anchor 12 such that second piece 104 of tensioning strap 78 may travel and/or remain with anchor 12 when anchor system 10 is not in active use.

With reference now to FIG. 3C, a third embodiment of upper strap assembly 14 is shown. This third embodiment may be substantially similar or identical to the prior embodiments and may again differ only in the attachment mechanism utilized to connect second piece 104 of tensioning strap 78 to anchor 12. Specifically, in this third embodiment, a leader 114 may be utilized having a second O-ring 80B to connect second end 112 of second piece 104 to the anchor 12 (with first O-ring 80A being the O-ring 80 connecting ladder attachment straps 76 and tensioning straps 78 together). According to this embodiment, leader 114 may be permanently or semi-permanently attached to crossbar 30 and second O-ring 80B via loops 96 and stitching 98, but may further provide a connection point to a quick-release fastener 100 on second end 112 of second piece 104, thus allowing for rapid installation and removal of tensioning strap 78 while simultaneously providing the secure connection between leader 114 and anchor 12.

With reference to FIG. 3D, a fourth embodiment of upper strap assembly 14 is shown. This fourth embodiment may be substantially similar or identical to the first three embodiments of upper strap assembly 14 except that the fourth embodiment may include a second ladder attachment strap 76 alongside first strap 84. This second strap is shown at reference 90 and may be substantially similar or identical to first strap 84 but for its placement in upper strap assembly 14. According to this embodiment, first strap 84 may be connected to a fastener 100 at first end 86 thereof while second end 88 may be securely connected to O-ring 80 via loop 96 and stitching 98. Similarly, second strap 90 may have a first end 92 connected to a fastener 100 while a second end 94 thereof may be securely connected to O-ring 80 via loop 96 and stitching 98. According to one aspect of this embodiment, the permanent or semi-permanent attachment of first and second straps 84 and 90 may allow for a more secure connection to O-ring. Further, as shown, the second ends 88 and 94 of first and second straps 84 and 90 may be fastened together through additional stitching 98 to provide a more secure attachment point and to further maintain the proper positional relationship between the first and second straps 84 and 90. Alternatively, first and second straps 84 and 90 may be entirely independent of each other.

It will be understood that the various embodiments of upper strap assembly 14 presented in FIGS. 3A-3D may be modified and may include interchangeable components. By way of one non-limiting example, the third embodiment utilizing leader 114 in FIG. 3C may likewise utilize first and second straps 84 and 90 for ladder attachment straps 76 from the fourth embodiment in FIG. 3D. Similarly, the fourth embodiment shown in FIG. 3D could readily utilize a fastener 100 to connect second piece 104 of tensioning strap 78 to anchor 12 but may also be modified to allow second piece 104 to connect directly to anchor 12, as shown in the second embodiment of FIG. 3B. Accordingly, it will again be understood that the embodiments shown in FIGS. 3A-3D are exemplary and are not limiting examples of upper strap assembly 14 modifications and/or implementations. In essence, upper strap assembly 14 may be modular in that the implementation parameters may dictate the type of fasteners 100 used, the number of ladder attachment straps 76, the connection mechanism connecting the attachment straps 76 and tensioning strap 78 to O-ring 80, and the type of connection between the tensioning strap 78 and anchor 12, and different embodiments or combinations thereof may be adapted for use in multiple differing implementations of anchor system 10.

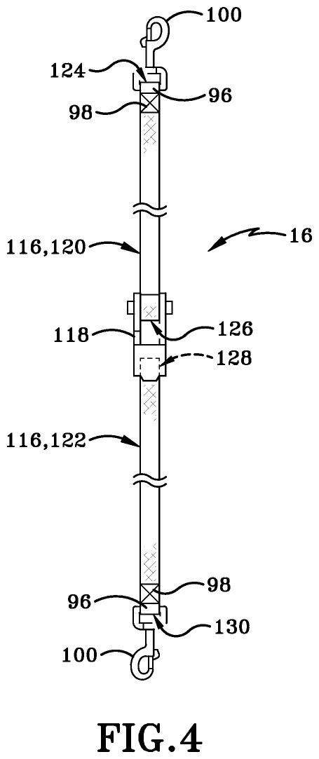

With reference to FIG. 4, a lower strap assembly 16 is shown and may generally include a base strap 116 and tensioning mechanism 118. Base strap 116 may be substantially similar to tensioning strap 98 but for its position within anchor system 10. Specifically, base strap 116 may have a first piece 120 and a second piece 122 connected by tensioning mechanism 118. First piece 120 and second piece 122 may connect at the ends thereof to fasteners 100 and/or tensioning mechanism 118 for operable engagement with a ladder 18 and with anchor 12, as discussed further below. In particular, first piece 120 of base strap 116 may have a first end 124 connected to a fastener 100 via loop 96 and stitching 98 with a second end 126 in operable connection with tensioning mechanism 118. Similarly, second piece 122 may have a first end 128 operably engaged with tensioning mechanism 118 and a second end 130 connected to a fastener 100 via loop 96 and stitching 98.

As with ladder attachment straps 76 and tensioning strap 78, base strap 116 may be formed of any suitable material including nylon webbing, canvas, or the like, and may optionally include an elastic property or elastic material to provide additional tension on base strap 116, as dictated by the desired implementation. Similarly, tensioning mechanism 118 may be substantially similar or identical to tensioning mechanism 82 but for its engagement with base strap 116 rather tensioning strap 78. Tensioning mechanism 118 may likewise be operable to take up slack in the base strap 116 to pull the base strap 116 tight and to provide lateral force on the ladder 18, as discussed below.

The operable connections of upper strap assembly 14 and lower strap assembly 16 will be best understood through the operation and use of ladder anchor system 10, which will now be discussed in more detail.

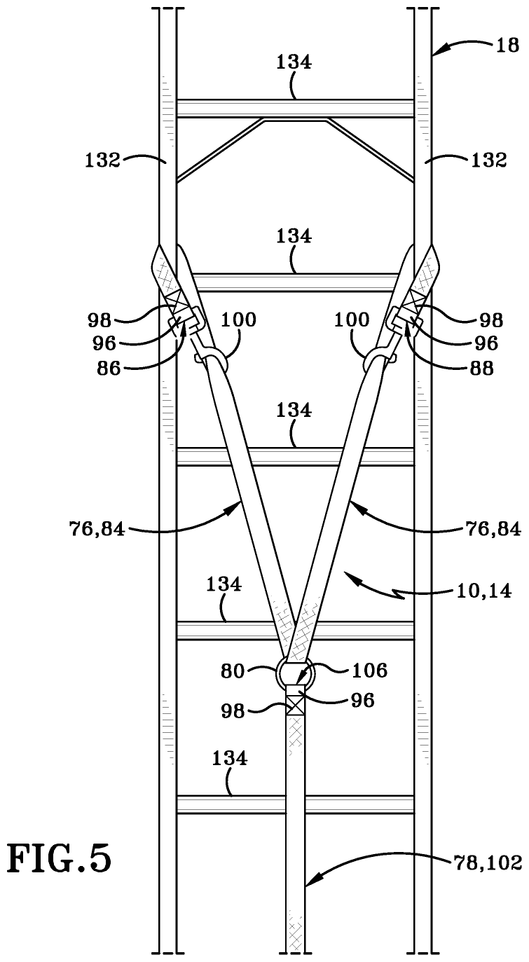

With reference to FIGS. 5-7, the ladder anchor system 10 may be installed on a ladder 18 having a pair of parallel side beams 132 and a plurality of rungs 132 orthogonal thereto and extending therebetween. As discussed above, anchor system 10 is contemplated for use with extension ladders or other similar unsupported or non-self-supporting ladders; however, anchor system 10 may be readily adapted for use with other ladder types and/or configurations, and/or with other devices, such as scaffolding, material slides, or the like.

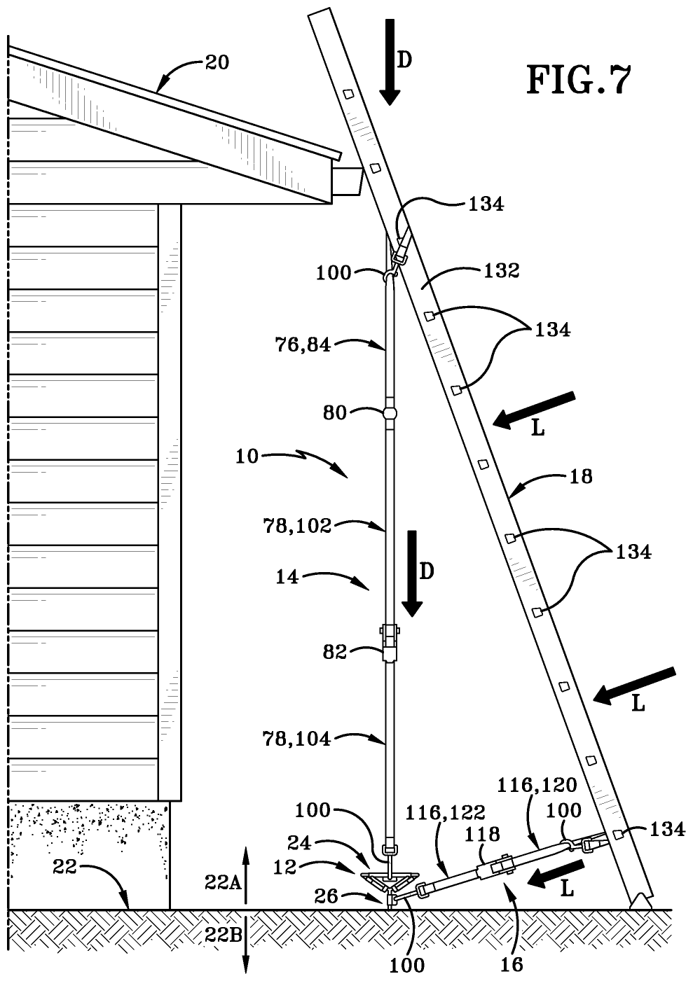

Before installing anchor system 10, the ladder 18 may be placed in position against an associated structure (see FIG. 7) with the base of the ladder 18 resting on the ground surface 22. The strap assemblies 14 and 16 and the anchor 12 may then be installed.

As seen in FIG. 5, upper strap assembly 14 of anchor system 10 may be connected to ladder 18 by wrapping the first end 86 of first strap 84 around one of the parallel side beams 132 of ladder 18 and the second end 88 of first strap 84 around the other one of the parallel side beams 132 of ladder 18 before looping them back and connecting the fasteners 100 back to first strap 84. As shown in FIG. 5, embodiments utilizing a single ladder attachment strap 76, namely first strap 84, is shown; however, connection to a ladder would be substantially identical utilizing two ladder attachment straps 76 wherein first strap 84 would be connected similarly to one of the side beams 132 and second strap 90 would be likewise connected to the other side beam 132 of ladder 18. By providing the open or V-shaped positioning of attachment straps 76 and the connection to each side beam 132 of the ladder, the downward force applied by upper strap assembly 14, as discussed below, will pull equally on both side beams 132 of the ladder 18 to provide secure engagement therewith. The first piece 102 of tensioning strap may now be connected to O-ring 80 via the fastener 100 on the first end 106 thereof.

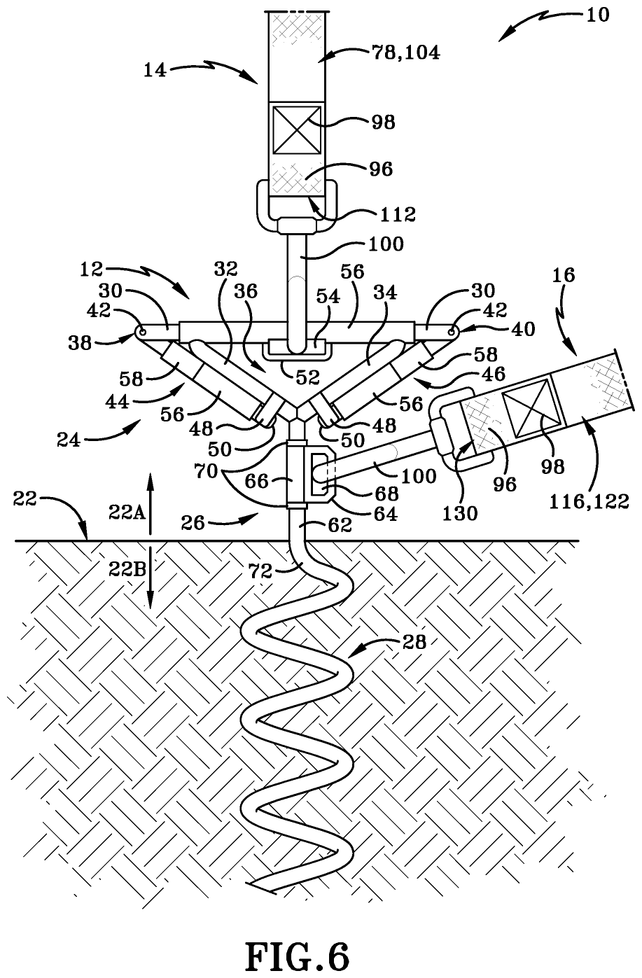

With reference now to FIG. 6, ground anchor 12 may be screwed into the ground surface 22 such that the anchor base is contained entirely below the surface 22, as indicated by arrow 22B, with first bend 72 adjacent to, approximately parallel with ground surface 22, or slightly below ground surface 22 as illustrated, while body 26 and handle section 24 of anchor 12 extend upward above ground surface, as indicated at arrow 22A. With ground anchor 12 in place and the ladder attachment strap(s) 76 of upper strap assembly 14 connected to the ladder 18, the tensioning strap 78 may be connected to the anchor 12. In particular, the second piece 104 of tensioning strap 78 may be connected to crossbar 30 through the D-ring aperture 54 defined by handle D-ring 52 to allow a secure connection between upper strap assembly 14 and ground anchor 12. Depending on the embodiment employed, the second piece 104 may be connected directly to crossbar 30, or may be connected through a fastener 100, and/or with an anchor 114, as dictated by the installation parameters.

With continued reference to FIG. 6 but additional reference to FIG. 2, the installation of ground anchor 12 into ground surface 22 may be accomplished by applying downward force to the handle section 24 while simultaneously applying rotational force to screw ground anchor 12 into the ground surface 22. To further facilitate this installation, first and second handles 44 and 46 may be extended away from clips 48 such that they are generally planar with crossbar 30 and extend from first and second ends 38 and 40 thereof, respectively. With the handles 44 and 46 in this extended position, slide lock 58 may be moved away from grips 56 on handles 44 and 46 and into position to lock handles 44 and 46 in place by preventing movement of handles 44 and 46 about pivot pin 42, as indicated at reference arrow B in FIG. 2. This may provide or otherwise facilitate the installation of ground anchor 12 into a ground surface 22, particularly into a harder surface such as packed or rocky soil.

As mentioned above, ground anchor 12 is contemplated for use with permeable ground surfaces such as soil, sand, clay, or the like and is not configured, as shown, for utilization in or on other solid surfaces such as concrete, asphalt, and/or stone. However, it will be understood that anchor 12 may be modified for use with or on such surfaces or alternatively, such surfaces may be modified to accept ground anchor 12, where desirable.

With reference to FIGS. 6 and 7, as with upper strap assembly 14, lower strap assembly 16 may be installed with the first end 124 of first piece 120 wrapped around the bottommost rung 134 of the ladder 18 (as best seen in FIG. 7) may be then fastened to itself utilizing fastener 100 similar to how ladder attachment straps 76 may attach to ladder side beams 132. The opposite end of base strap 116, namely second end 130 of second piece 122, may then be connected to D-ring 66 by attaching fastener 100 through D-ring aperture 68 to secure base strap 116 to the body 26 of anchor 12 (as best seen in FIG. 6).

With reference now to FIG. 7, with upper strap assembly 14 connected to the ladder via ladder attachment straps 76 and to ground anchor 12 through tensioning straps 78 and lower strap assembly 16 connected to ladder 18 via base strap 16, the tensioning mechanisms 82 and 118 may be utilized to take up any slack in the upper and/or lower strap assemblies 14 and/or 16 and to pull the ladder 18 tightly towards the ground anchor 12. In particular, upper strap assembly may apply downward force on the upper portion of the ladder indicated by Arrows D to pull the ladder against the associated structure 20 and down towards the ground surface 22. Similarly, base strap 116 may apply a lateral force indicated at arrows L in FIG. 7, which may be angled slightly downward towards anchor 12 to pull the ladder in the base of ladder 18 in towards the associated structure 20 and simultaneously downward into engagement with ground surface 22 to secure ladder 18 in position, against preventing tipping or shifting of ladder 18 during use.

As described, anchor system 10 may be quickly and easily installed with a ladder 18 to secure ladder 18 against an associated structure 20 and against a ground surface 22 but may be rapidly disconnected and easily stored allowing for the ease of use and transportation thereof along with providing the benefits of securing a ladder tightly against a structure 20 to prevent accidental tipping or movement of the ladder 18 during use. Similarly, the flexibility imparted by using the strap and anchor system of anchor system 10 allows for easy adjustment to account for height, positioning, and/or proper footing for ladder 18 depending upon the exact operational environment. Put another way, anchor system 10 is easily adjusted to account for structures of varying heights and/or uses where the base of ladder 18 may need to be moved closer or further away from the structure to account for obstacles and/or to put the base of ladder 18 on more even ground.

As discussed throughout the disclosure herein, many modifications and/or adaptations may be readily apparent as dictated by the desired implementation of anchor system 10 and such modifications are contemplated to be included in the disclosure herein.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A ladder anchoring apparatus comprising:
a ground anchor having a handle, a body, and a base operable to securely engage a ground surface;
an upper strap assembly having at least one ladder attachment strap operable to connect to a ladder and a tensioning strap operable to connect the at least one ladder strap to the ground anchor; and
a lower strap assembly operable to connect to the ladder at a first end thereof and to the ground anchor at a second end thereof.

2. The apparatus of claim 1 wherein the handle of the ground anchor further comprises:
a crossbar;
a first side bar;
a second side bar; and
at least one extendable handle at an end of the crossbar;
wherein the at least one extendable handle is movable between a first position wherein the at least one extendable handle is parallel and adjacent to one of the first and second side bars and a second position wherein the at least one extendable handle extends outwardly from the end of the crossbar and is substantially planar therewith.

3. The apparatus of claim 2 wherein the ground anchor further comprises:
a first D-ring on the crossbar defining a first D-ring aperture for operable connection to the tensioning strap; and
a second D-ring on the body defining a second D-ring aperture for operable connection to the lower strap assembly.

4. The apparatus of claim 2 further comprising:
a first extendable handle at a first end of the crossbar; and
a second extendable handle at a second end of the crossbar;
wherein the first extendable handle is movable between a first position wherein the first extendable handle is parallel and adjacent to the first side bar and a second position wherein the first extendable handle extends outwardly from the first end of the crossbar and is substantially planar therewith, and wherein the second extendable handle is movable between a first position wherein the second extendable handle is parallel and adjacent to the second side bar and a second position wherein the second extendable handle extends outwardly from the second end of the crossbar and is substantially planar with the crossbar and the first extendable handle.

5. The apparatus of claim 4 further comprising:
a first slidable lock sleeve on the first handle operable to lock the first handle in the second position; and
a second slidable lock sleeve on the second handle operable to lock the second handle in the second position.

6. The apparatus of claim 1 wherein the tensioning strap of the upper strap assembly further comprises:
a tensioning mechanism operable to take up slack in the upper strap assembly to provide downward force on the ladder.

7. The apparatus of claim 1 wherein the upper strap assembly further comprises:
at least one quick-release fastener at an end of the at least one ladder attachment strap operable to connect the at least one ladder attachment strap to the ladder;
an O-ring between the at least one ladder attachment strap and the tensioning strap;
at least one additional quick-release fastener operable to connect a first piece of the tensioning strap to the O-ring; and
at least another additional quick-release fastener operable to connect a second piece of the tensioning strap to the ground anchor.

8. The apparatus of claim 1 wherein the lower strap assembly further comprises:
a base strap having a first piece and a second piece;
at least one quick-release fastener at an end of the first piece of the base strap operable to connect the base strap to the ladder; and
at least one additional quick-release fastener operable to connect the second piece of the base strap to the ground anchor.

9. The apparatus of claim 1 wherein the base of the ground anchor is substantially below the ground surface when engaged therewith.

10. A method of securing a ladder comprising:
placing a ladder in position on a ground surface and against an associated structure;
engaging a ground anchor having a handle portion, a body, and a base with the ground surface;
connecting a first end of at least one ladder attachment strap to a first side rail of the ladder and a second end of the at least one ladder attachment strap to a second side rail of the ladder;
connecting a first end of a tensioning strap to the at least one ladder strap and a second end of the tensioning strap to the ground anchor;
connecting a first end of a lower strap assembly to the ladder and a second end of the lower strap assembly to the ground anchor;
applying downward force on the ladder towards the ground anchor by applying tension to the tensioning strap via a first tensioning mechanism operably engaged therewith; and
applying lateral force on the ladder towards the ground anchor by applying tension to the lower strap assembly via a second tensioning mechanism operably engaged therewith.

11. The method of claim 10 wherein connecting the at least one ladder attachment strap to the ladder further comprises:
connecting a first end of a first ladder strap to the first side rail of the ladder;
connecting a second end of the first ladder strap to the tensioning strap;
connecting a first end of the second ladder strap to the second side rail of the ladder; and
connecting a second end of the second ladder strap to the tensioning strap.

12. The method of claim 10 wherein connecting a first end of a tensioning strap to the at least one ladder strap further comprises;
connecting the at least one ladder strap to an O-ring; and
connecting the tensioning strap to the O-ring.

13. The method of claim 10 wherein connecting the at least one ladder strap to the ladder, connecting the tensioning strap to the ground anchor, and connecting the lower strap assembly to the ladder and to the anchor are each accomplished with a quick-release fastener.

14. The method of claim 10 wherein engaging the ground anchor with the ground surface further comprises:
moving a first extendable handle from a first position wherein the first extendable handle is parallel and adjacent to a first side bar of the handle portion to a second position wherein the first extendable handle extends outwardly from a first end of a crossbar of the handle portion and is substantially planar with the cross bar; and
moving a second extendable handle from a first position wherein the second extendable handle is parallel and adjacent to a second side bar of the handle portion to a second position wherein the second extendable handle extends outwardly from a second end of the crossbar of the handle portion and is substantially planar with the cross bar and the first handle portion.

15. The method of claim 14 further comprising:
sliding a first lock sleeve from the first handle to the crossbar lock the first handle in the second position; and
sliding a second lock sleeve from the second handle to the crossbar to lock the second handle in the second position.

16. The method of claim 15 further comprising:
rotating the ground anchor about a vertical axis defined by the body thereof to screw the base of the ground anchor into the ground surface.

17. A ground anchor comprising:
a crossbar;
a first side bar;
a second side bar, the crossbar, first side bar, and second side bar defining a handle section;
at least one extendable handle at an end of the crossbar, the at least one extendable handle is movable between a first position wherein the at least one extendable handle is parallel and adjacent to one of the first and second side bars and a second position wherein the at least one extendable handle extends outwardly from the end of the crossbar and is substantially planar therewith;
a body; and
a base operable to securely engage a ground surface.

18. The ground anchor of claim 17 further comprising:
a first D-ring on the crossbar defining a first D-ring aperture for operable connection to a tensioning strap of a ladder anchoring apparatus; and
a second D-ring on the body defining a second D-ring aperture for operable connection to a lower strap assembly of the ladder anchoring apparatus.

19. The ground anchor of claim 17 further comprising:
a first extendable handle at a first end of the crossbar; and
a second extendable handle at a second end of the crossbar;
wherein the first extendable handle is movable between a first position wherein the first extendable handle is parallel and adjacent to the first side bar and a second position wherein the first extendable handle extends outwardly from the first end of the crossbar and is substantially planar therewith, and wherein the second extendable handle is movable between a first position wherein the second extendable handle is parallel and adjacent to the second side bar and a second position wherein the second extendable handle extends outwardly from the second end of the crossbar and is substantially planar with the crossbar and the first extendable handle.

20. The ground anchor of claim 19 further comprising:
a first slidable lock sleeve on the first handle operable to lock the first handle in the second position; and
a second slidable lock sleeve on the second handle operable to lock the second handle in the second position.
